(19) United States
(12) Patent Application Publication
(10) Pub. No.: US 2003/0194554 A1
(43) Pub. Date: Oct. 16, 2003

(54) Powder coating with metallic and chromatic pigments and method for preparing the same

(76) Inventors: James L. Petersen, Wyoming, MN (US); Paul S. Crea, Stillwater, MN (US); Kevin P. Poblocki, Apple Valley, MN (US)

Correspondence Address: H.B. Fuller Company, Patent Dept., 1200 Willow Lake Blvd., P.O. Box 64683, St. Paul, MN, 55164-0683, US

(21) Appl. No.: 10/253,758

(22) Filed: Sep. 23, 2002

Related U.S. Application Data
(60) Provisional application No. 60/328,442, filed on Oct. 12, 2001.

(51) Int. Cl. B05D 3/02

(52) U.S. Cl. 428/402; 427/195

(57) ABSTRACT

The invention relates to a two-part powder coating system in which the first part includes at least one film-forming polymer, at least one chromatic pigment, and at least one metallic-effect pigment and the second part is substantially free of chromatic pigment. The first part, when applied to at least one surface of a substrate to form a base powder coating and cured in the absence of the second part, is adapted to reflect incident white light in a color substantially independent of the color of the chromatic pigment. The second part, when applied to the top of the base coating to form a clear coating and cured, is adapted to reflect incident white light in a color that is a function of the combined colors of the chromatic pigment and metallic effect pigment. The invention also relates to a process for powder coating a substrate using two-part powder coating system and an article made thereby.

### FIELD OF THE INVENTION

The invention relates to a two-part powder coating system that produces a chromatic and metallic effect surface coating. More specifically, the invention relates to a two-part powder coating system in which a first part incorporates at least one chromatic pigment and at least one metallic effect pigment while the second part is substantially free of chromatic pigment.

### BACKGROUND OF THE INVENTION

Powder coatings may be used as an alternative to solvent-based coatings. They are applied to various articles for protecting and/or decorating the article. Although applied in powder form, powder coatings generally undergo a process during which the powder form material is transformed into a substantially continuous polymer film. Typically, the polymer material in the powder coatings is a thermosetting polymer, and the transformation into a substantially continuous polymer film coincides with a cross-linking, or cure, of the thermosetting polymer.

Powder coatings may be formed by intimately mixing ingredients in dry or molten form, by mixing in liquid suspension, or by methods involving solution polymerization. Application of the resultant powder form materials to a desired article is achieved by a variety of mechanisms, including electrostatic spray, or fluidized bed immersion. In an electrostatic spray process, particles of a powder coating composition are electrostatically charged, and the charged particles are attracted to the article that is grounded or oppositely charged. In a fluidized bed immersion process, powdered or particulate coating material is contained within a dipping tank. A flow of gas or liquid through the coating material fluidizes the material to form a fluidized bed. This allows easy passage of the article through the fluidized bed. Typically, a pre-heated article is put into the fluidized bed. As the powdered or particulate coating material contacts the heated article, the coating material adheres to at least one surface of the article where it forms a more or less continuous coating. It is known to prepare a powder coating composition in which a powdered or particulate thermosetting coating material is provided as part of a blend or mixture that further includes leafing or non-leafing metallic flake pigments. U.S. Pat. No. 6,166,123 describes reflective powder coating compositions and the method of preparing the same. The reflective powder coating compositions include a thermally softenable resin powder and highly reflective particles, such as non-leafing or leafing metallic flake, mica, and the like. The reflective powder coating compositions provide, after cure, shiny, reflective metallic coatings with high-gloss ranging from sparkling, to specular or mirror-like. The resultant coatings exhibit metallic coloration including e.g., silver or other metallic colors depending on the particular metallic pigment incorporated in the powder coating compositions.

In some applications, however, it is desirable to provide a highly reflective glossy powder coating finish such as that provided by U.S. Pat. No. 6,166,123, but exhibiting chromatic appearance that differs from that of the included metallic pigment. To achieve this, a conventional approach is to produce a two-layer coating, in which a first layer of a polymeric powder coating includes a metallic pigment and is applied to a substrate. Thereafter, a second layer of a polymeric powder coating including a chromatic pigment is applied over the first layer. In practice, it has been discovered that the resultant coloration is not uniform across the coating surface. It is believed that this non-uniformity results from variations in the thickness of the second layer as measured across the surface of the deposited second layer.

Accordingly, there is a need for a powder coating that provides uniform, durable, and attractive chromatic color in a sparkling or specular metallic-effect finish.

### SUMMARY OF THE INVENTION

In one aspect, the invention relates to a two-part powder coating system including a first part and a second part. The first part includes a first substantially uniform powder mixture that includes at least one film-forming polymer, at least one chromatic pigment, and at least one metallic-effect pigment. The second part includes a second substantially uniform powder mixture that includes at least one film-forming polymer and that is substantially free of chromatic pigment. The first part, when applied to at least one surface of a substrate to form a base coating and cured in the absence of the second part, is adapted to reflect incident white light in a color substantially independent of the color of the chromatic pigment. The second part, when applied to the top of the base coating to form a clear coating and cured, is adapted to reflect incident white light in a color that is a function of the combined color of the chromatic pigment and the metallic-effect pigment.

In another aspect, the invention relates to a process for powder coating a substrate including (a) applying a first powder coating composition on at least one surface of the substrate to form a base coating thereon, the first powder coating composition is substantially free of solvent and includes at least one film-forming polymer, at least one chromatic pigment, and at least one metallic-effect pigment; (b) applying a second powder coating composition on top of the base coating to form a clear coating, the second powder coating composition is substantially free of solvent and chromatic pigment; and (c) curing the base coating and the clear coating under conditions effective to cause at least a portion of the chromatic pigment to migrate from the base coating into the clear coating to produce a combined chromatic and metallic effect surface coating.

In yet another aspect, the invention relates to an article produced by the aforesaid process. The article includes (a) a substrate having at least one surface; (b) a cured base coating on at least one surface of the substrate, the base coating is produced from a base powder coating composition that is substantially free of solvent and that comprises at least one film-forming polymer, at least one chromatic pigment, and at least one metallic-effect pigment; and (c) a cured clear coating on top of the base coating, the clear coating is produced from a clear powder coating composition that is substantially free of solvent and chromatic pigment. The article exhibits a chromatic appearance caused by at least a portion of the chromatic pigment's migrating into the clear coating during cure.

The present invention provides a unique and innovative two-part powder coating system in which the base coating includes chromatic pigment(s) while the top clear coating is substantially free of chromatic pigment. Once being applied on a substrate consecutively and cured, the two-part powder coating system produces a surface coating that exhibits combined desirable chromatic and metallic effect coloration.

In particular, the produced surface coating exhibits very uniform coloration regardless of the variations of the thickness of the top clear coating. Upon visual inspection, the color of the cured coating is consistent such that there is no substantially visible color change throughout the entire coating surface of the substrate or from one substrate to another coated with the same two-part coating system, relative to the conventional approach in which a pigmented top coating is applied over a layer of metallic powder base coat.

The present invention also provides a unique and innovative process for producing a chromatic and metallic effect surface coating using the two-part powder coating system of the invention.

It has been observed that by adding a chromatic pigment to a powder coating composition, such as that of U.S. Pat. No. 6,166,123, and applying on a substrate, the cured coating does not necessarily exhibit the chromatic appearance as would have been expected. For example, a powder coating composition including leafing aluminum flake produces a cured surface coating with silver metallic color. By further incorporating a chromatic pigment, e.g., an orange pigment to the powder coating composition, the resultant cured coating would not exhibit visible chromatic appearance, but a similar silver metallic color to that of the coatings without the incorporated chromatic pigment.

Uniquely, the inventive process produces a desirable chromatic surface coating by using the two-part powder coating system of the invention, in which a first part includes a chromatic pigment and a metallic-effect pigment and the second part is substantially free of chromatic pigment. When the first part is applied on at least one surface of a substrate and cured by itself, the cured coating exhibits essentially metallic coloration without substantial visible chromatic coloration. However, when the second part is applied over the first part coating and cured, the cured coating exhibits a distinct chromatic coloration in combination with the metallic-effect coloration.

Further, the process of the invention can also produce a chromatic and metallic effect surface coating with the desirable and/or improved luster, depth and hue.

The article produced by the inventive process using the two-part powder coating system of the invention exhibits a chromatic appearance in combination with the desirable metallic-effect coloration and the desirable luster, depth and hue depending on the intended end use.

In some embodiments, the article prepared according to the process of the invention has a colored specular surface, capable of clearly reflecting an image. The article exhibits good depth of color, and reflectivity.

In some embodiments where the non-leafing metallic pigment(s) are incorporated, the article retains the traditional metallic sparkle appearance, while incorporating a semi-transparent chromatic color as well. The apparent color of the cured coating may also vary with the viewing angle.

### BRIEF DESCRIPTION OF THE DRAWINGS

FIG. 1 is a mode of the process of the invention in flow chart form for making an article including dry blending of chromatic pigment according to one aspect of the invention.

FIG. 2 is an alternative mode of the process of the invention in flow chart form for making an article including melt mixing of chromatic pigment according to another aspect of the invention.

FIG. 3 is an alternative mode of the process of the invention in flow chart form for making an article including high shear blending of chromatic pigment according to another aspect of the invention.

FIG. 4 is a schematic view in cross-section of the structure of an article having a layered powder coating according to one aspect of the invention.

FIG. 5 is a graph of CIEL*a*b* b* vs. Base Coat Film Build, as discussed in Example 25.

FIG. 6 is a graph of CIELab b* vs. Clear Coat Film Build, as discussed in Example 26.

FIG. 7 is a graph of CIELab b* vs. Base Coat Film Build, as discussed in Example 30.

### DETAILED DESCRIPTION OF THE INVENTION

The two-part powder coating system of the invention includes a first part and a second part. The first part includes a first substantially uniform powder mixture and is substantially free of solvent including, e.g., organic solvent and water. The powder mixture includes at least one film-forming polymer, at least one chromatic pigment, and at least one metallic-effect pigment.

The film-forming polymers include thermosetting polymers or resins used in powder coating compositions. Examples of useful thermosetting polymers or resins include, e.g., epoxy resins such as diglycidyl ethers of bisphenol A and epoxy cresol/novolacs; phenolic resins such as novolacs and resols; polyurethanes such as polyester resins with blocked isocyanate groups; saturated polyesters such as saturated terephthalic acid based polyesters and carboxylated polyesters; acrylics based on crosslinkable acrylate resins such as carboxyl terminated resins; polysilaxanes and other silicon resins; self-crosslink etherified methoxylated resins based on acrylamides and/or methacrylamides. Polyester resins such as those derived from isophthalic anhydride/glycol and trimellitic anhydride/glycol are also examples of useful materials as well as those disclosed in U.S. Pat. No. 6,166,123, which is hereby incorporated by reference in its entirety.

Useful chromatic pigments include any chromatic pigments used in conventional powder coating compositions, such as organic and inorganic pigments. Preferably, chromatic pigments are organic pigments such as organo reds, phthalocyanine blues and greens, organic yellows and violets, and other organic dyes. Examples of useful organic chromatic pigments include, e.g., Diarylide Yellow (C.I. Pigment Yellow 14), Monoazo Orange (C.I Pigment Orange 67), Benzimidazole Derivative Yellow (C.I Pigment Yellow 151), Azo Yellows (C.I Pigment Yellow 194, 191 and 83), Pyrazolone Orange (C.I Pigment Orange 34), Metalized Organic Yellow (C.I Pigment Yellow 153), Quinacridone Violet (C.I Pigment Violet 19), Azo Red (C.I Pigment Red 187), Dis Azo Orange (C.I Pigment Orange 34, and Carbazole Violet (C.I Pigment Violet 23).

The amount of the chromatic pigment(s) used in the two-part powder coating system depends on the specific pigment selected or the combination of the pigments selected and the requirements for the end product coloration. Typically, the chromatic pigment(s) is present in an amount effective to provide the desirable chromatic coloration on the cured coatings. Preferably, the chromatic pigment(s) is present in an amount of from about 0.01 wt % to about 50 wt %, and more preferably from about 0.01 wt % to about 10 wt %, based on the total weight of the powder coating system.

The first part of the two-part powder coating system also includes at least one metallic-effect pigment. The metallic-effect pigment refers to a pigment that generates metallic effect or special effect on the cured coatings. Special effect includes, such as, color shift, movement, fluorescence, pearlescence, etc. depending on the requirements for the end product. The metallic-effect pigment may be in any suitable shapes such as particles, flakes, etc. depending on the requirements for the end products. Examples of useful metallic-effect pigments include such as leafing and non-leafing metallic pigments, e.g., bronze, gold, copper, brass, titanium, silver, aluminum; metal-coated particles or flakes, e.g., leafing or non-leafing aluminum particles or flakes; and micas as well as those disclosed in U.S. Pat. No. 6,166,123 and U.S. Pat. No. 6,162,856, incorporated herein by reference in their entirety.

The amount of the metallic-effect pigment(s) used in the two-part powder coating system depends on the specific pigment selected or the combination of the pigments selected and the requirements for the end product coloration. Typically, the metallic-effect pigment is present in an amount effective to produce the desirable metallic effect on the cured coatings when combined with the effect of the chromatic pigment. Preferably, the metallic-effect pigment is present in an amount of from about 0.1 wt % to about 25 wt %, and more preferably, from about 1.0 wt % to about 7.0 wt %, based on the total weight of the powder coating system.

The second part of the two-part powder coating system includes a second substantially uniform powder mixture and is also substantially free of solvent including, e.g., organic solvent and water. The second powder mixture includes at least one film-forming polymer and is substantially free of chromatic pigment. The film-forming polymer in the second powder mixture may be the same as or different from the film-forming polymer in the first powder mixture. Preferred examples of the film-forming polymers used in the second powder mixture include such as epoxy resins, acrylic resins, and polyester resins. The second powder mixture may or may not include metallic effect pigment depending on the requirements for the end product.

Each of the first and the second powder mixtures may include other ingredients commonly used in the powder coating compositions such as curing agents, flow control agents, degassing agents, catalysts, fillers, UV stabilizers, fluidizing agents, coalescing agents, and other additives.

The first and the second powder mixtures may be prepared separately using powder coating technology. For example, each powder mixture may be prepared by melt blending all the ingredients in an extruder. Alternatively, the chromatic pigment and/or the metallic-effect pigment may be post-incorporated into the first powder mixture by dry-blending or melt-blending the pigment(s) with the preformed powder mixture. Or, the metallic-effect pigment(s) may be incorporated first into the first powder mixture through the conventional “bonding” processes or the processes as disclosed in U.S. Pat. No. 6,166,123 and U.S. Pat. No. 6,162,856, and then, the chromatic pigment(s) may be further incorporated by dry-blending into the powder mixture.

In another aspect, the invention relates to a process for powder coating a substrate using the two-part powder coating system of the invention. The process includes (a) applying the first part of the two-part powder coating system on at least one surface of a substrate to form a base coating thereon; (b) applying the second part of the two-part powder coating system on top of the base coating to form a clear coating; and (c) curing the base coating and the clear coating under conditions effective to cause at least a portion of the chromatic pigment to migrate from the base coating into the clear coating to produce a chromatic and metallic effect surface coating.

In some preferred embodiments, the base coating is first heated to the extent that the first powder mixture would melt and flow. The second part of the powder coating system is then applied over the base coating. Surprisingly, by heating the base coating prior to applying the clear coating, the cured coatings exhibit different chromatic appearance compared to that of the cured coatings incorporating the same chromatic and metallic-effect pigments without heating, which provides more options for the coloration of the end products.

In more preferred embodiments, the base coating is cured prior to applying the second part of the powder coating system. In such a case, the substrate with the cured base coating may be stored for a period prior to applying the second part, which provides more options and convenience for the manufacturers to finish the final articles. Also surprisingly, by curing the base coating prior to applying the clear coating, the cured coatings exhibit different chromatic appearance compared to that of the cured coatings incorporating the same chromatic and metallic-effect pigments with heating, therefore, even more options for the coloration of the end products.

In yet another aspect, the invention relates to an article manufactured by the aforesaid process of the invention using the two-part powder coating system of the invention. The article includes a substrate and a cured surface coating thereon exhibiting a uniform chromatic appearance with optical reflectance. The cured surface coating is formed of two deposited layers or coatings, one is the base coating and the other one is a clear coating that is deposited on top of the base coating.

Remarkably, the color exhibited by the article of the invention differs markedly from that of a comparable article coated only with a cured base coating including both chromatic and metallic pigment. While the color of the comparable article would be silver metallic with little or no visible chroma, the color of the article of the invention is not silver metallic, but a strong color according to the color of the chromatic pigment incorporated in the base coating. Moreover, the resultant coloration of the article is significantly more uniform than the coloration of another comparative article coated with a cured base coating include only metallic pigment and a cured top coating including chromatic pigment.

It is believed, but not limited to, that the unique chromatic appearance on the surface coating of the article of the invention is due to a diffusion or migration of the chromatic pigment from the base coating into the clear coating during cure. The distribution of the chromatic and metallic pigments achieved thereby appears to include a layer of chromatic pigment disposed between a reflective layer that is formed by the metallic pigment near the top of the base coating and the top surface of the clear coating (i.e. the exposed surface of the second or top coating that is outwardly of the substrate). This layer of chromatic pigment is believed to reside, at least in part, in the top clear coat.

Further, the article of the invention displays excellent gloss, reflectance, and color properties. Additional coating properties such as impact resistance, hardness, adhesion, etc. are controlled by the film-forming polymer(s) or resin binder system used in the powder coatings. The article can be used, e.g., as auto components and equipment, furniture, industrial and domestic equipment, safety and recreational equipment, and lighting fixtures. Metal substrates to be coated by the method of the invention are those coated by electrostatic spray, or by fluidized bed coating. Specific examples of useful metal substrates are those of iron, copper, aluminum, tin, zinc, or like metals, alloys containing such metals, metal parts made with such metals, those coated with such metals by vapor deposition, bodies of automobiles, trucks, motorcycles, buses having such metal parts, electric appliances, etc. Other useful substrates include e.g., wood, plastic and composites.

The two-part powder coating system, the process and the article of the invention as well as other aspects of the invention will be further illustrated with reference to the attached figures and the examples described below.

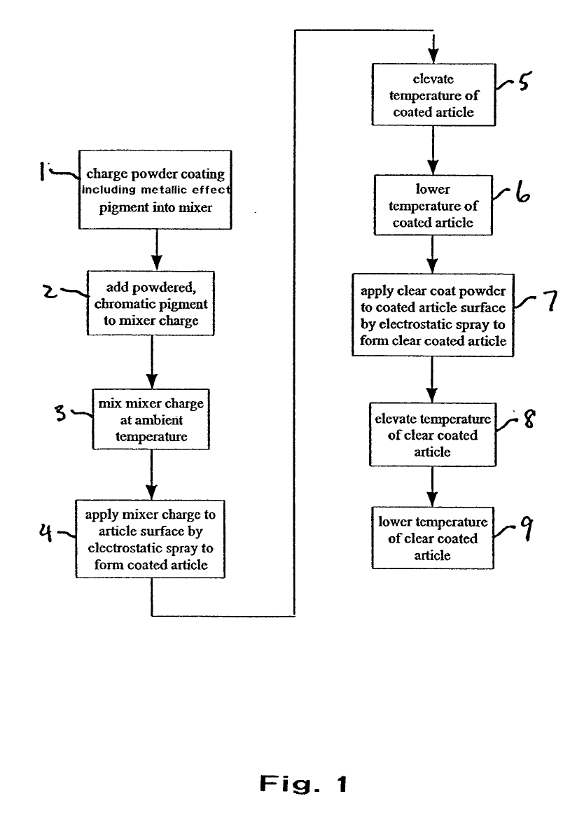

Referring to FIG. 1, which depicts in block diagram form a mode of practicing the inventive process for making a two-part powder coating system and coating a substrate. A powder coating composition including a metallic effect pigment, such as IF7567 commercially available from H. B. Fuller Company, is charged into a mixer (1). Powdered chromatic pigment is added to the mixer (2), and the two components thus charged in the mixer are mixed at ambient temperature (3) until the chromatic pigment is uniformly distributed in the powder coating composition to form a pigmented powder coat composition. Depending on the mixer, the duration of mixing will range from seconds to hours, and more typically from seconds to minutes. Once the chromatic pigment is uniformly distributed in the powder coating composition, the powder mixture or the composition is applied with an electrostatic spray apparatus to the surface of an article to be coated (4). The coated article is then heated using, e.g., an oven for a time sufficient to allow the powder coating to either melt and flow or optionally, to cure (5). Optionally, the article may be cooled thereafter (6). Electrostatic spray apparatus is then used to apply a layer of a clear coat powder coat composition to the base coating (7), and the temperature of the article is once again elevated (8). The article is maintained at an elevated temperature until the coating(s) is (are) cured, and the article is then allowed to cool to ambient temperature (9).

The process described above produces an article coated with a two-layer powder coating. The cured powder coating exhibits coloration that is different from the coloration of the first layer when it is cured in the absence of the top clear layer, as observed prior to application of the clear coat layer, and also different from the clear coat alone, which is typically transparent.

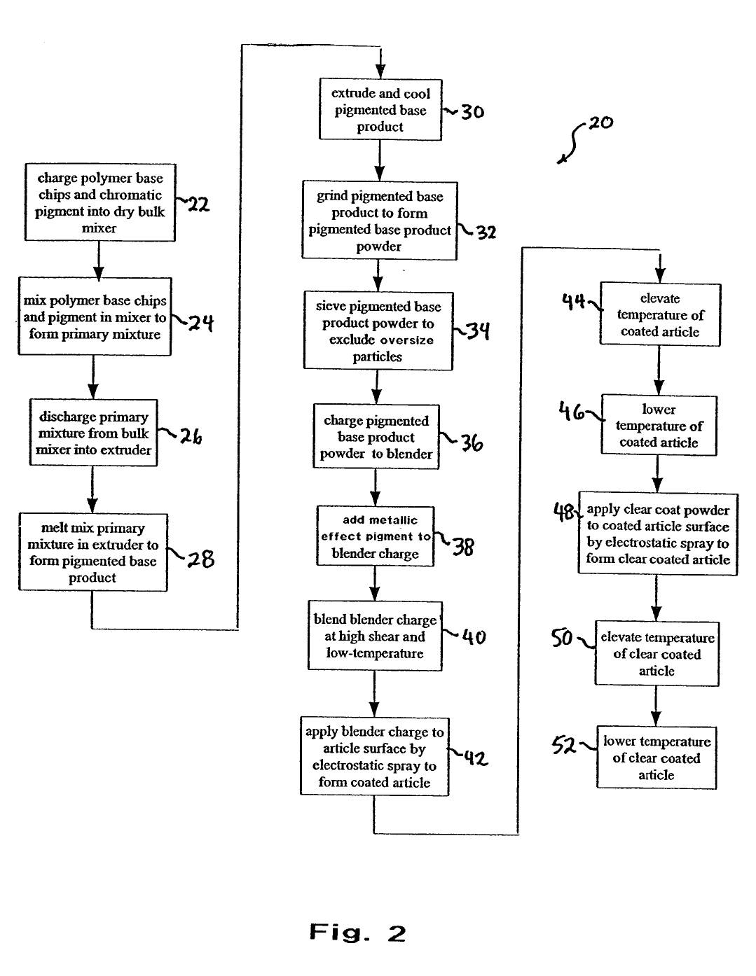

FIG. 2 illustrates an alternative mode of process 20 for forming a powder coating on an article in accordance with the invention. In FIG. 2, chips of a film-forming polymer base material are charged into a dry bulk mixer along with a powdered chromatic pigment (22). The mixer mixes the polymer base chips and the pigment to form a primary mixture (24). This primary mixture is then discharged from the dry bulk mixer into the intake of an extruder (26). Thereafter, the primary mixture is melt mixed in the extruder to form a pigmented uniform base mixture (28). The pigmented base mixture is extruded through the extruder to form an extrudate, cooled, either in ambient air, chilled air, or water, and chipped (30). The chipped pigmented extrudate is ground e.g., in an Alpine grinder to form a pigmented base composition powder (32). The powder is sifted through a sieve, such as a sieve of from about 50 mesh to about 230 mesh, preferably, from about 80 mesh to about 200 mesh, to remove any unduly large particles from the powder (34). The result is a pigmented polymer powder composition well adapted to the application to an article by electrostatic spray or fluidized bed processing. This pigmented powder composition is charged into a high shear blender (36). A metallic effect pigment such as leafing aluminum flake is also charged into the blender (38). The blender is connected to a source of coolant and is operated to blend the charge of pigmented powder and metallic pigment at high shear while maintaining the temperature of the blender charge below, or well below the glass transition temperature (Tg) (40). After the metallic effect pigment and pigmented polymer powder composition are blended, the composition is applied by electrostatic spray to a surface of an article to be coated (42). The temperature of the coated article is elevated to fuse (i.e., applied powder mixture melts and flows) and/or cure the coating to form a fused and/or a cured base coating (44). When the base coating is fused or partially or fully cured, the article may be optionally cooled (46), and a second powder coating composition is applied to the coated surface of the article (48). The second coating composition is a clear coating powder mixture applied using electrostatic spray. The article is then heated again to cure the clear coating and the base coating (50) in case the base coating is not cured in step (44). Finally, the twice-coated article is cooled (52). The resultant article exhibits the desirable surface coloration features as described above.

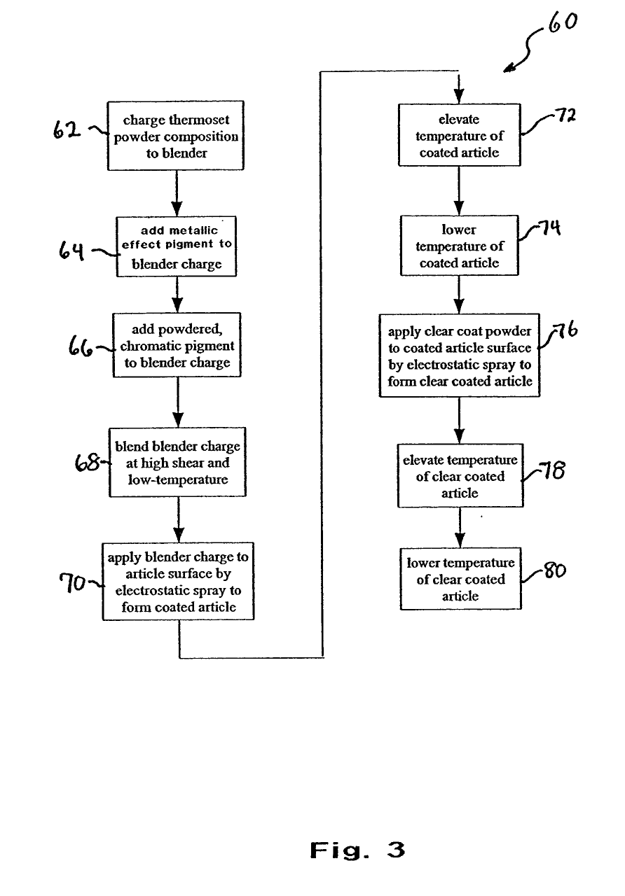

FIG. 3 shows another alternative mode of the process of the invention (60). In FIG. 3, a thermoset powder composition is charged into a high speed blender (62). Metallic flake pigment is added to the blender charge (64). Chromatic pigment is also added to the blender charge (66). The blender is then operated at high shear and low temperature such that the temperature of the blender charge remains below the glass transition temperature (Tg) of the powder composition throughout the blending (68). The blending is continued until any agglomerations of the particles of the metallic flake pigment are thoroughly dispersed and all pigments are uniformly dispersed throughout the blender charge. Thereafter, the blender charge is applied to a surface of an article using electrostatic spray (70) to form a pigmented powder coating. The coated article is then heated to fuse and/or cure the base coating (72). Generally, the cured base coating exhibits a color according to the metallic effect pigment(s) used. The article may be optionally cooled (74). A second polymer powder composition is then applied to the base coated article by electrostatic spray to form a clear coating coated article (76). The clear coating coated article is heated (78) to cure the clear coat powder (78), and then cooled (80).

As would be understood by one of skilled in the art, the process of the invention described above can be performed in batch or in continuous fashion.

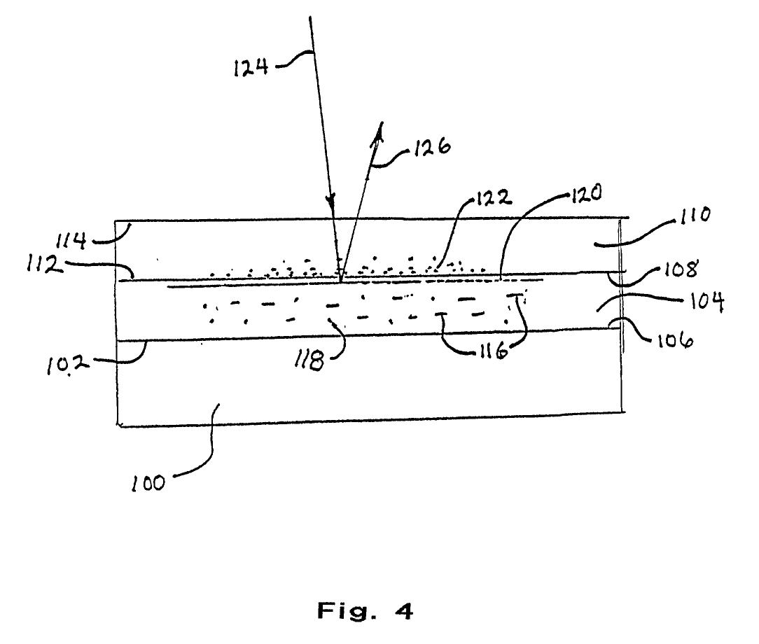

FIG. 4 shows a schematic view in cross-section of a coated article 100 according to one aspect of the present invention. The article 100 includes a first surface 102. A first layer (or base coating) 104 of pigmented powder coating composition is disposed on the first surface 102. The first layer 104 includes a second surface 106 in contact with the first surface 102, and a third surface 108 disposed in substantially parallel spaced relation to the second surface 106. A second layer 110 of initially unpigmented powder clear coat is disposed on the third surface 108. The second layer 110 includes a fourth surface 112, in contact with the third surface 108, and a fifth surface 114 disposed in substantially parallel spaced relation to the fourth surface 112. Prior to curing of the second layer 110, the first layer 104 includes metallic pigment 116 and chromatic pigment 118. At that time, the second layer 110 includes no significant amount of pigment. During cure of the first layer 104, the leafing metallic pigment 116 forms a substantially continuous boundary 120 in the first layer 104 adjacent the third surface 108. After curing of the second layer 110, a portion of the chromatic pigment 118 initially found in the first layer 104 has migrated or diffused into the second layer 110. This diffused pigment 122 is thereafter found in the second layer 110.

White light 124 incident on the fifth surface 114 passes through the second layer 110, is reflected off of the boundary 120, passes back through the second layer 110, and out through the fifth surface 114 as reflected light 126. As it traverses the second layer 110, the white light is affected by the chromatic pigment 122 disposed therein. Consequently, the color of the reflected light 126 is a function of the color of the chromatic pigment 122.

The invention is further illustrated through the following non-limiting examples. It should be understood, however, that many variations and modifications may be made while remaining within the scope of the present invention. All parts, ratios, percentages and amounts stated in the examples are by weight unless otherwise specified.

### EXAMPLES

Test Procedures

Test procedures used in the examples include the following.

Gloss

The 20° and 60° gloss of the cured powder coatings is measured according to the Standard Test Method for Specular Gloss of ASTM D523.

Color Difference

The color difference is measured using a MacBeth spectrophotometer (Gretag Macbeth, New Windsor, N.Y.) at the test settings of 10° observer, D65 illuminant and calculated using CIEL*a*b*color equations.

In the examples, the extruder is an APV twin screw extruder (APV Baker, Grand Rapids, Mich.). Mixing equipment includes, e.g., the Waring blender (Waring Division of Conair, Stamford, Conn.), the Mixaco mixer (Mixaco Maschinenbau Neuenrade, Germany) and the Welex blender (formerly Gunther Papenmeier, 493 Detmold 18, Germany, now Defunct). Unless indicated otherwise, all the test panels are 3″×5″×0.02″ steel panels commercially available as Q-Panel™ test panel (Q-Panel Lab Products, Cleveland, Ohio). In general, test-panels are coated at various film builds and cured at the temperatures and time intervals indicated in the examples. A reflective silver metallic coating powder composition IF 7567 (commercially available from H. B. Fuller Company) is used in some of the examples. The composition is comprised in one embodiment of a urethane base (BS 7566) and a leafing aluminum pigment. The composition capable of forming a coating with 20° gloss of 525-625 is achieved by mixing the ingredients at high speed, while keeping the mixture below about 40° C. Other reflective coatings are described in U.S. Pat. No. 6,162,856 and U.S. Pat. No. 6,166,123, which are incorporated herein by reference. Typical film build for a base coating formed from IF 7567 is 1.5-5 mils, and preferably 2.0-3.0 mils.

### Example 1

Two powder coating compositions, Trial A and Trial B were prepared by mixing the ingredients according to Table 1 in an APV extruder and extruded at zone 1 and zone 2 temperatures of 150° F. and 250° F., respectively. The resultant extrudate was ground in an Alpine grinder, then sieved through a 200 mesh sieve. Samples were prepared in 5 pound batches. The specific gravity of each of Trial A and Trial B was 1.181. The percent stoichiometry of each of Trial A and Trial B was 121.3.

TABLE 1

| | Trial A | Trial B |
|---|---|---|
| Ingredients | Weight (g) | Weight (g) |
| 30 OH Polyester Resin | 85 | 85 |
| Ecap Blocked IPDI* | 15 | 15 |
| Acrylic Flow Control | 1.5 | 1.5 |
| Benzoin | 1 | 1 |
| Modified Azo Orange Pigment | 0.3 | 0.6 |

*Isophorone Di-isocyanate curing agent

### Example 2

A sample panel exhibiting a violet coloration was prepared according to one aspect of the invention.

199 g of a powder coating composition IF7567 (a urethane based reflective metallic coating, H. B. Fuller Company) was charged into a Waring blender along with 2 g of Carbozol Violet Pigment 23. The mixture was blended for 30 seconds, and then applied on a test panel using electrostatic spray to form a base coating. The base coating was cured at 375° F. for 15 minutes. Thereafter, a clear coating composition IF4444 (a polyester/TGIC based powder coating composition, H. B. Fuller Company) was applied over the base coating by electrostatic spray. The test panel was baked at 375° F. for an additional 15 minutes. Upon visual inspection, the panel exhibited a violet undertone.

### Example 3

An acrylic based powder coating composition as listed in Table 3 was prepared according to the procedure of Example 1, except that the flow control post blend was added after the extrusion. Samples were prepared in 2.5 pound batches.

TABLE 3

| Ingredients | Weight (g) |
|---|---|
| GMA acrylic resin | 76 |
| Bisphenol A epoxy resin | 4 |
| DDDA* | 20 |
| Acrylic flow control | 1.2 |
| Benzoin | 0.3 |
| Flow control post blend** | 0.2% |

*Dodecanedioic Acid
**aluminium oxide, weight percent, based on the total weight of the composition

### Example 4

A powder coating composition as listed in Table 4 was prepared according to the procedure of Example 1, Trial A, except that the modified azo orange pigment was not included.

TABLE 4

| Ingredients | Weight (g) |
|---|---|
| COOH Polyester Resin | 85 |
| Ecap Block IPDI | 15 |
| Acrylic Flow Control | 1.5 |
| Benzoin | 1 |

### Examples 5A and 5B

Two powder coating compositions, 5A and 5B as listed in Tables 5 and 6, respectively, were prepared according to the procedure of Example 3, except that the extruder zone 1 and zone 2 temperatures were 100° F. and 200° F., respectively.

TABLE 5

| | 5A |
|---|---|
| Ingredients | Weight (g) |
| 33 COOH Polyester Resin | 93 |
| TGIC | 7 |
| Benzoin | 0.3 |
| Flow control post blend | 0.2% |

TABLE 6

| | 5B |
|---|---|
| Ingredients | Weight (g) |
| 33 COOH Polyester Resin | 93 |
| TGIC | 7 |
| Benzoin | 0.3 |
| Monazo orange pigment of the | 0.2 |
| benzimidazolone series | |
| Monazo yellow pigment of the | 0.1 |
| benzimidazolone series | |
| Flow control post blend | 0.2% |

### Example 6

A powder coating composition as listed in Table 7 was prepared by dry-blending IF 7567 with modified azo orange pigment in a Waring blender for 30 seconds at ambient temperature. The mixture was then sieved through an 80 mesh sieve.

TABLE 7

| | Weight (g) |
|---|---|
| IF7567 | 99.7 |
| Modified azo orange pigment | 0.3 |

Test panels were prepared by electrostatically spraying the resultant composition on Q-panels at a variety of thickness and cured at 375° F. for 10 minutes. Upon visional inspection, the panels exhibit a color similar to that of coatings formed of IF 7567 with no modified azo orange pigment.

### Example 7

A powder coating composition as listed in Table 8 was prepared by dry-blending the composition of Example 5A with modified azo orange pigment and non-leafing aluminum pigment in a Waring blender for 30 seconds. About 0.1% by weight flow control post blend was then added to the mixture, and the mixture was blended again for 15 seconds. The mixture was then sieved through an 80 mesh sieve.

TABLE 8

| Ingredients | Weight (g) |
|---|---|
| Composition of Example 5 A | 95.7 |
| Non-leafing aluminum pigment | 4 |
| Modified azo orange pigment | 0.3 |
| Flow control post blend | 0.1% |

### Example 8

Coatings formed from IF7567 were prepared for the purposes of comparison.

Sample panels were prepared by coating IF7567 on Q-panels at various film builds and curing the coated panels at 375° F. for 15 min. Typical film build thickness for this product is from about 1.5 mils to about 5.0 mils, and preferably about 2.0 mils to about 3.0 mils. Upon visional inspection, the panels exhibit a reflective silver-metallic color.

One panel having a film build thickness of about 2.2 to about 2.4 mils was selected and measured three times at three different locations (designated as Locations #1, #2, and #3) using a MacBeth spectrophotometer at the test settings of 10° observer, D65 illumination and using CIELab color equations. The test results are shown in Tables 9 and 10.

TABLE 9

| | Lightness (L*) | +Red/−green (a*) | +Yellow/−blue (b*) |
|---|---|---|---|
| Location #1 | 79.921 | −0.058 | 1.300 |
| Location #2 | 79.729 | −0.055 | 1.282 |
| Location #3 | 80.403 | −0.058 | 1.314 |

Using location #1 as standard:

TABLE 10
Color Differences*

| | DL* | Da* | Db* | DE* |
|---|---|---|---|---|
| Location #1 | — | — | — | — |
| Location #2 | −0.193 | 0.003 | −0.018 | 0.193 |
| Location #3 | 0.482 | 0.000 | 0.013 | 0.482 |

*D = Delta (Δ)

Accordingly, the same panel can read 0.482 DE*, for example from location to location.

### Example 9

A sample panel was prepared by electrostatically spraying the powder coat composition of example 6 (including IF 7567 and a chromatic pigment) on several Q-panels at a various film thicknesses. The coatings were then cured at 375° F. for 10 minutes.

The resultant panel has 20° gloss of 393 and 60° gloss of 436. Upon visional inspection, the panels exhibited an appearance very similar to that of IF 7567.

A panel having a film thickness of 2.1-2.3 mils was tested using MacBeth spectrophotometer and test conditions as described in Example 8. The test results are shown in Table 11 and Table 12.

TABLE 11

| | Lightness (L*) | +Red/−green (a*) | +Yellow/−blue (b*) |
|---|---|---|---|
| Location #1 | 79.089 | 0.340 | 1.547 |
| Location #2 | 79.066 | 0.342 | 1.501 |
| Location #3 | 79.908 | 0.341 | 1.531 |

Using location #1 as standard:

TABLE 12
Color Differences

| | DL* | Da* | Db* | DE* |
|---|---|---|---|---|
| Location #1 | — | — | — | — |
| Location #2 | −0.23 | 0.002 | −0.047 | 0.052 |
| Location #3 | −0.181 | 0.001 | −0.016 | 0.182 |

The test results show the color uniformity from spot to spot within one given panel.

### Example 10

In this example, a panel coated with unpigmented IF 7567 was compared to a panel coated with pigmented IF7567, as prepared in example 6.

A panel of pigmented IF7567 having a base coat film build of 2.1-2.3 mils was selected from the set of test panels prepared in example 6. This panel was tested on the MacBeth spectrophotometer. Observation was made at 10°, with D65 lighting, and CIELab color equation. The recorded readings are shown in Tables 13 and 14.

TABLE 13

| | Lightness | +Red/−green | +Yellow/−blue |
|---|---|---|---|
| | (L*) | (a*) | (b*) |
| Example 8 (IF7567) | 79.921 | −0.058 | 1.300 |
| Example 6 (Pigmented | 79.094 | 0.334 | 1.491 |
| IF7567) | | | |

Using IF7567 of Example 8 as standard:

TABLE 14

| | DL* | Da* | Db* | DE* |
|---|---|---|---|---|
| Example 8 (IF7567) | — | — | — | — |
| Example 6 (Pigmented IF7567) | −0.828 | 0.392 | 0.191 | 0.935 |

Tables 13 and 14, above, show the similarity of results between a panel coated with standard IF7567, and a panel coated with pigmented IF7567 as prepared in example 6, where neither the pigmented nor the unpigmented coating was covered with a clear coat. This result contrasts strongly with the results presented below for a clear coated pigmented IF7567.

### Example 11

A sample panel was prepared by electrostatically spraying the powder coating composition of Example 6 on a test panel to form a base coating. The base coating was then cured. The film thickness of the base coating was 1.7-2.0 mils. The powder coating composition of example 5A was then applied on top of the base coating to form a clear top coating and cured at 375° F. for 15 minutes. The clear coating had a thickness of 1.7 mils. The resultant panel had a 20° gloss of 124 and a 60° gloss of 130.

Upon visional inspection, the panel exhibited a color similar to that of bright polished brass. This color was remarkably different from the reflective silver metallic color of Example 9 panel.

The panel was also tested using MacBeth spectrophotometer and test conditions as described in Example 8. The test results are listed in Tables 15 and 16.

TABLE 15

| | Lightness (L*) | +Red/−green (a*) | +Yellow/−Blue (b*) |
|---|---|---|---|
| Location #1 | 73.002 | −3.820 | 18.332 |
| Location #2 | 72.740 | −4.011 | 19.627 |
| Location #3 | 73.142 | −3.867 | 18.552 |

Using location #1 as standard:

TABLE 16
Color Differences

| | DL* | Da* | Db* | DE* |
|---|---|---|---|---|
| Location #1 | — | — | — | — |
| Location #2 | −0.262 | −0.191 | 1.295 | 1.335 |
| Location #3 | 0.140 | −0.047 | 0.220 | 0.265 |

In contrast to the test panels coated only with the base coat of example 6, as examined in example 9, the panels of the present example, coated with both the composition of example 6 and, subsequently, the composition of example 5A, had a 20° gloss of 124 and a 60° gloss of 130. The panels of the present example appear very green and yellow, as compared with the panels of example 9 which exhibit a specular silver-like appearance. The panels of the present example exhibit a color and appearance close to that of bright brass. Color readings were taken as above, and the results are presented in tables 17 and 18 below.

TABLE 17

| | Thickness | Thickness | | | |
|---|---|---|---|---|---|
| | of | of | | | |
| | base | clear | | | |
| | coating | coating | Lightness | +Red/−green | +Yellow/−blue |
| Panel | (mils) | (mils) | (L*) | (a*) | (b*) |
| 1* | 1.8-2.0 | 0 | 79.190 | 0.333 | 1.486 |
| 2 | 1.7-1.8 | 1.8-1.9 | 73.439 | −3.958 | 19.007 |
| 3 | 1.7-2.0 | 1.7 | 72.971 | −3.840 | 18.609 |
| 4 | 2.1-2.2 | 1.7-1.9 | 73.051 | −4.219 | 21.237 |

*Panel 1 was made according to Example 9 and used as standard:

TABLE 18
Color Differences

| Panel | DL* | Da* | Db* | DE* |
|---|---|---|---|---|
| 1* | — | — | — | — |
| 2 | −5.751 | −4.291 | 17.521 | 18.933 |
| 3 | −6.219 | −4.173 | 17.123 | 18.689 |
| 4 | −6.139 | −4.552 | 19.751 | 21.178 |

As shown by Table 18, the panels exhibit uniform coloration. Further comparing to Table 14 of Example 10, significant color differences indicate substantially different coloration achieved by the invention.

### Example 12

In example 6 above, the pigmented base coat composition was prepared by dry blending a modified azo orange pigment with IF7567. In the present example, a further pigmented base coat composition was prepared.

Two powder coating compositions listed in Table 19 as Batch A and Batch B were prepared by mixing in a Mixaco mixer all the ingredients except flow control post blend. Each mixture was blended at a temperature under 40° C. (and well below the glass transition temperature of the composition) so as to produce a composition capable of forming a reflective film having a 20° gloss of 700. Then the flow control post blend was added and mixed at 265 RPM for one minute. The resultant powder compositions were sieved through a 150 mesh screen.

TABLE 19

| | Batch A | Batch B | Batch C |
|---|---|---|---|
| Ingredients | Weight (g) | Weight (g) | Weight (g) |
| Trial A of Example 1 | 99 | — | — |
| Trial B of Example 1 | — | 99 | — |
| Leafing aluminum pigment | 1 | 1 | 1 |
| Modified azo orange pigment | — | — | 0.3 |
| BS 7566 Urethane Base* | — | — | 99 |
| Flow control post blend | 0.2% | 0.2% | 0.2% |

*a urethane based powder coating composition from H. B. Fuller Company.

A third powder coating composition listed in Table 19 as Batch C was prepared following the same procedure above except the following: mixing all the ingredients except the modified azo orange pigment and the flow control post blend so as to form a composition capable of forming a reflective film having a 20° gloss of 700. Then, the orange pigment was added and mixed for one minute at 265 RPM. Thereafter, the flow control post blend was added and mixed at 265 RPM for one minute.

Three panels were electrostatically sprayed with each of Batch A, B and C to form a base coating and cured at 375° F. The film build of the cured coatings was 1.7-3 mils. The base coated panels were then electrostaticaly coated with the powder coating composition of Example 5A and cured at 400° F. for 10 min. The thickness of the clear top coating for the top half of each test panel was from 1.4-1.8 mils and for the bottom half of each test panel was 2-2.5 mils.

By visual observation, a very light color change was noted between the top and the bottom regions of the panels having different clear coating thickness, indicating uniform coloration and negligible color change following the coating thickness change in all three panels.

In addition, the colors of the two panels coated with Batches A and B as base coatings were duller than that of panel coated with Batch C with Batch B panel being brighter than Batch A panel. Batch A and B panels also had a slightly red-orange undertone that was not evident in Batch C panel.

### Example 13

A powder coating composition listed in Table 20 was prepared by blending the ingredients in a Waring blender for 30 seconds.

TABLE 20

| Ingredients | Weight (g) |
|---|---|
| IF7567 | 99.75 |
| Modified azo orange pigment | 0.25 |

The resultant composition was electrostatically sprayed on a test panel and baked at 375° F. for 15 minutes to form a base coating. Thereafter, a powder coating composition IF 4444 (a polyester/TGIC based powder coating composition commercially available from H. B. Fuller Company) was electrostatically sprayed on top of the base coating and baked at 375° F. for 15 minutes. The resultant panel exhibits slightly green and slightly pale color in comparison to brass.

### Example 14

A powder coating composition as listed in Table 21 was blended in the Waring blender for 30 seconds. It was then electrostatically sprayed onto a test panel, and baked at 375° F. for 15 minutes. Thereafter, the test panel was electrostatically sprayed with powder coating composition IF 4444 and baked at 375° F. for 15 minutes. The resultant color was noted to be very pale in comparison to brass.

TABLE 21

| Ingredients | Weight (g) |
|---|---|
| IF7567 | 199.5 |
| Dis azo Pigment Orange 34 | 0.5 |

### Example 15

A powder coating composition as listed in Table 22 was blended in the Waring blender for 30 seconds. It was electrostatically sprayed onto a test panel, and baked at 375° F. for 15 minutes. Thereafter, the test panel was electrostatically sprayed with powder coating composition IF 4444 and baked at 375° F. for 15 minutes. The resultant color was noted to be very pale in comparison to brass.

TABLE 22

| Ingredients | Weight (g) |
|---|---|
| IF7567 | 199.2 |
| Dis azo Pigment Orange 34 | 0.8 |

### Example 16

A powder coating composition as listed in Table 23 was blended in the Waring blender for 30 seconds. It was electrostatically sprayed onto a test panel and baked at 375° F. for 15 minutes. Thereafter, the test panel was electrostatically sprayed with the powder coating composition IF 4444 and baked at 375° F. for 15 minutes. The resultant color was noted to be very strong. The color is slightly greener than brass, and may be too chromatic for some applications.

TABLE 23

| Ingredients | Weight (g) |
|---|---|
| IF7567 | 199.2 |
| Dis azo Pigment Orange 34 | 0.5 |
| Modified azo orange pigment | 0.3 |

### Example 17

A powder coating composition as listed in Table 24 was blended in the Waring blender for 30 seconds. The composition was then electrostatically sprayed onto a test panel, and baked at 375° F. for 15 minutes. Thereafter, the test panel was electrostatically sprayed with the powder coating composition IF 4444 and baked at 375° F. for 15 minutes. The resultant color was slightly redder than a copper penny.

TABLE 24

| Ingredients | Weight (g) |
|---|---|
| IF7567 | 99.5 |
| Naphtol Red CI Pigment Red 170 | 0.2 |
| Modified azo orange pigment | 0.3 |

### Example 18

A powder coating composition as listed in Table 18 was blended in the Waring blender for 30 seconds. It was then electrostatically sprayed on a test panel and baked at 375° F. for 15 minutes. Thereafter, the test panel was electrostatically sprayed with the powder coating composition IF 4444 and baked at 375° F. for 15 minutes. The resultant color was noted to be strong and very much like gold.

TABLE 25

| Ingredients | Weight (g) |
|---|---|
| IF7567 | 99.86 |
| Naphtol Red CI Pigment Red 170 | 0.375 |
| Dis azo Pigment Orange 34 | 0.025 |
| Modified azo orange pigment | 0.0625 |

### Example 19

A powder coating composition as listed in Table 26 was blended in the Waring blender for 30 seconds. It was then electrostatically sprayed on a test panel and baked at 375° F. for 15 minutes. Thereafter, the test panel was electrostatically sprayed with the powder coating composition IF4444 and baked at 375° F. for 15 minutes. The resultant color was noted to be closer to copper than gold.

TABLE 26

| Ingredients | Weight (g) |
|---|---|
| IF7567 | 99.5 |
| Naphtol Red CI Pigment Red 170 | 0.15 |
| Modified azo orange pigment | 0.35 |

### Example 20

A powder coating composition as listed in Table 27 was blended in the Waring blender for 30 seconds. It was then electrostatically sprayed on a test panel and baked at 375° for 15 minutes. Thereafter, the test panel was electrostatically sprayed with the powder coating composition IF4444 and baked at 375° F. for 15 minutes. The resultant color was noted to be redder than the gold of example 18.

TABLE 27

| Ingredients | Weight (g) |
|---|---|
| IF7567 | 99.81 |
| Naphtol Red CI Pigment Red 170 | 0.085 |
| Dis azo Pigment Orange 34 | 0.035 |
| Modified azo orange pigment | 0.085 |

### Example 21

20° gloss of panels prepared according to Examples 13 and 17-20 was measured and listed in Table 28.

TABLE 28

| | Example | | | | |
|---|---|---|---|---|---|
| | 13 | 17 | 18 | 19 | 20 |
| Initial gloss* at 20° | 433 | 407 | 514 | 405 | 499 |
| Final gloss** at 20° | 276 | 250 | 316 | 247 | 294 |

*measured prior to applying the clear powder coating composition.
**measured after applying the composition IF4444 and cured at 375° F. for 15 min.

In addition, panels were prepared using an epoxy based powder coating composition IF4271 (commercially available from H. B. Fuller Company), instead of IF4444, as clear coating composition and cured at various conditions and inspected visually as follows:

none of the panels cured at 325° F. for 20 minutes developed more than a hint of color;

for panels cured at 375° F. for 15 minutes, color developed in a fashion similar to that of examples 13 and 17-20.

For panels cured at 425° F. for 15 minutes, color developed more intense than that cured at 375° F. for a comparable duration. Also, some qualitative color shift was noted, as described in Table 29 below.

TABLE 29

| Panel Prepared | Resultant Color |
|---|---|
| According to*: | Characteristics |
| Example 13 | much greener, may be just |
| | the color development |
| Example 17 | much more orange or yellow, |
| | and perhaps not as red |
| Example 18 | much yellower and much less red |
| Example 19 | much yellower and much less red |
| Example 20 | much yellower and much less red |

*IF4271 was used as clear coating composition instead of IF4444 in preparing these panels.

### Example 22

In this example, the effect of substrate thickness on coating color is examined. The test configurations of example 21 were repeated in all respects, except that a ¼ inch thick aluminum panel was used in place of each Q-panel. The observed result was that there was some loss of color when the quarter inch aluminum panel was used in comparison to when the Q-panel was used.

### Example 23

Panels prepared according to Example 6 and Example 12, Batch B were further tested as follows.

A panel prepared according to example 12, Batch B with a film build thickness of 2.4-2.5 mil was measured to have a 20° gloss of 508 and a 60° gloss of 357. Visually, the panel prepared according to example 12 exhibited very similar appearance to that of a panel prepared according to Example 6. Tables 30 and 31, below show MacBeth spectrophotometer readings taken at test conditions as described in Example 8.

TABLE 30

| | Lightness | +Red/−green | +Yellow/−blue |
|---|---|---|---|
| Panel prepared with: | (L*) | (a*) | (b*) |
| IF7567 | 79.921 | −0.058 | 1.300 |
| Example 6 | 75.978 | 0.390 | 1.442 |
| Example 12 | 79.094 | 0.334 | 1.491 |

Using panel coated with IF7567 as standard:

TABLE 31

| Panel prepared with: | DL* | Da* | Db* | DE* |
|---|---|---|---|---|
| IF7567 | — | — | — | — |
| Example 6 | −3.944 | 0.448 | 0.142 | 3.972 |
| Example 12 | −0.828 | 0.392 | 0.191 | 0.935 |

Panels prepared according to Example 12, Batch B were further clear coated with the composition of Example 5A. These panels exhibited a dramatic color change and an appearance similar to bright brass. One panel having a base coat film build thickness of 1.8-1.9 mils and a clear coat film build thickness of 1.8-1.9 mils had a 20° gloss of 99.5 and a 60° gloss of 107. Panels were tested using MacBeth spectrophotometer, as described above, and the results are presented in Tables 32 and 33 below.

TABLE 32
Color Numbers of Clear Coated and
Non-Clear Coated Panels

| | Base Coat | Clear Coat | | | |
|---|---|---|---|---|---|
| Test | film build | film build | Lightness | +Red/−green | +Yellow/−blue |
| Panel | (mils) | (mils) | (L*) | (a*) | (b*) |
| 1 | 2.4-2.5 | 0 | 75.899 | 0.401 | 1.466 |
| 2 | 1.8-1.9 | 1.8-1.9 | 70.354 | −3.201 | 16.838 |
| 3 | 2.1-2.5 | 1.6 | 69.704 | −3.376 | 18.133 |
| 4 | 2.3-2.5 | 2.2 | 69.504 | −3.694 | 20.366 |
| 5 | 2.3-2.5 | 1.6-2.1 | 69.515 | −3.196 | 17.732 |
| 6 | 2.7-3.2 | 1.6-2.0 | 70.105 | −3.266 | 17.133 |

Using test panel 1 as standard:

TABLE 33
Color Change Difference with Clear Coat

| Test Panel | DL* | Da* | Db* | DE* |
|---|---|---|---|---|
| 1 | — | — | — | — |
| 2 | −5.545 | −3.602 | 15.372 | 16.741 |
| 3 | −6.195 | −3.777 | 16.667 | 18.178 |
| 4 | −6.395 | −4.095 | 18.900 | 20.396 |
| 5 | −6.383 | −3.596 | 16.266 | 17.840 |
| 6 | −5.794 | −3.666 | 15.667 | 17.102 |

### Example 24

This example compares the color characteristics of a panel coated with the example 12, Batch B base coating composition, then with the example 5A top coating composition to that of a panel coated only with the example 12, Batch B base coating composition.

Test panel 2 from Example 23 was tested using MacBeth spectrophotometer and test conditions as described in Example 8. The recorded readings are shown in Tables 34 and 35.

TABLE 34
Color Consistency within Panel 2 of Example 23

| | Lightness (L*) | +Red/−green (a*) | +Yellow/−blue (b*) |
|---|---|---|---|
| location #1 | 70.365 | −3.169 | 16.767 |
| location #2 | 70.167 | −3.298 | 17.608 |
| location #3 | 70.483 | −3.258 | 17.050 |

Using Location #1 as standard:

TABLE 35
Color Differences

| | DL* | Dg* | Db* | DE* |
|---|---|---|---|---|
| location #1 | — | — | — | — |
| location #2 | −0.198 | −0.129 | 0.841 | 0.873 |
| location #3 | 0.117 | −0.089 | 0.283 | 0.319 |

Further, a panel coated with the composition of example 12 Batch B only (i.e., without clear coat) was tested following the same procedure above for comparison.

TABLE 36
Color Consistency With different Location
Without Clear Coat

| | Lightness (L*) | +Red/−green (a*) | +Yellow/−Blue (b*) |
|---|---|---|---|
| location #1 | 75.978 | 0.390 | 1.442 |
| location #2 | 75.523 | 0.427 | 1.506 |
| location #3 | 75.704 | 0.414 | 1.487 |

Using location #1 as standard:

TABLE 37
Color Differences

| | DL* | Da* | Db* | DE* |
|---|---|---|---|---|
| location #1 | — | — | — | — |
| location #2 | −0.454 | 0.037 | 0.064 | 0.460 |
| location #3 | −0.274 | 0.023 | 0.044 | 0.278 |

By inspection of the Tables above, there may be some color difference numerically (using the spectrophotometer) within a metallic powder coating, even when measured across the same panel. Under visual inspection, however, panels coated with the composition of example 12 Batch B and prepared according to various aspects of the present invention look very uniform in color. It has been observed that a panel coated with standard composition IF 7567 and clear coated according to aspects of the present invention also look very uniform in color. When clear coated with the composition of example 5A there may be slightly more color variability, as measured using the spectrophotometer. Under visual inspection, however, the panels look very uniform.

### Example 25

This example presents a film build ladder showing the color characteristics resulting from changing the thickness of the pigmented metallic base coating. The test panels were coated with the base coating composition of example 12 Batch B. The base coating composition was applied by electrostatic spray. The panels were cured at 375° F. for 10 minutes. Then the panels were coated with the clear coating composition of example 5A. The clear coating was applied to a target film built of 1.5-2.0 mils. Color readings were then taken on MacBeth spectrophotometer at test conditions as described in Example 8. The results are shown below in Tables 38 and 39.

TABLE 38
Raw Color Number Base Coat Film Build Ladder

| | Base Coat | Clear Coat | | | |
|---|---|---|---|---|---|
| Sam- | Film build | Film build | Lightness | +Red/−green | +Yellow/−blue |
| ple | (mils) | (mils) | (L*) | (a*) | (b*) |
| A | 1.3-1.4 | 1.6-1.7 | 70.364 | −3.004 | 15,858 |
| B | 1.8-1.9 | 1.8-1.9 | 70.353 | −3.260 | 16.758 |
| C | 2.2-2.5 | 1.9-2.1 | 70.473 | −2.797 | 14,222 |
| D | 2.7-3.2 | 1.6-2.0 | 70.107 | −3.370 | 17.464 |
| E | 3.7-4.2 | 2.2 | 70.704 | −3.690 | 18.611 |

Using sample A as standard:

TABLE 39
Color Differences through Film Build Ladder

| Sample | DL* | Da* | Db* | DE* |
|---|---|---|---|---|
| A | — | — | — | — |
| B | −0.011 | −0.256 | 0.900 | 0.936 |
| C | 0.109 | −0.207 | −1.636 | 1.653 |
| D | −0.257 | −0.363 | 1.606 | 1.668 |
| E | 0.340 | −0.686 | 2.753 | 2.857 |

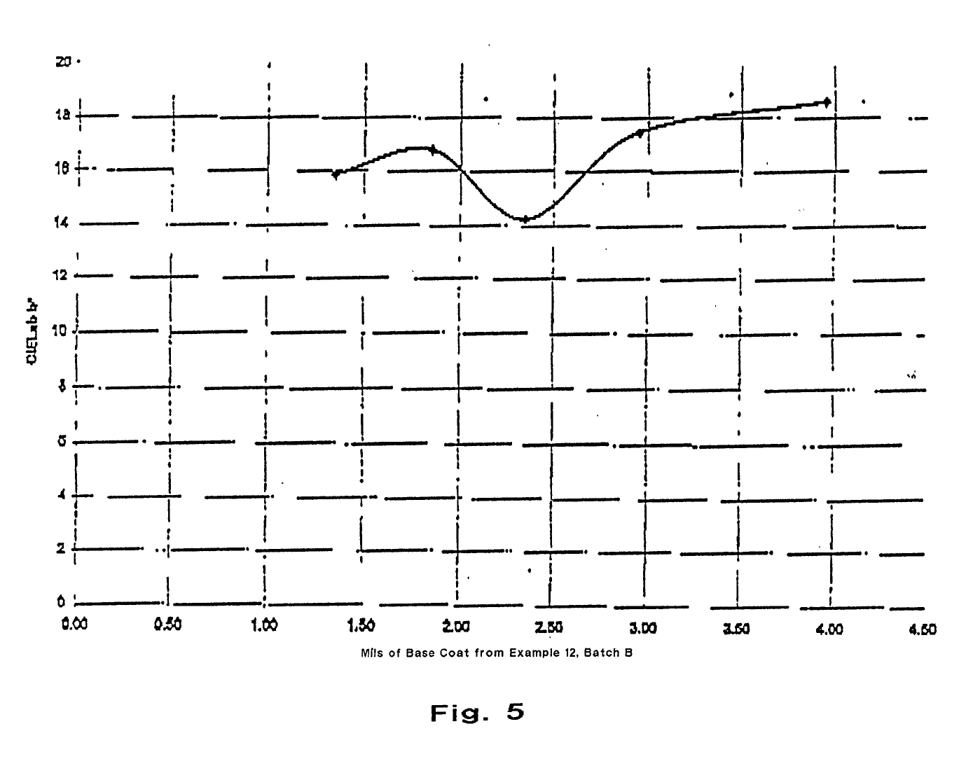

FIG. 5 shows a plot of CIELab b* vs. base coat film build. There is some trend toward yellow (higher b*) with increasing base coat film build. This trend toward yellow is not, however, visually apparent even over the very broad film build range presented in this example.

### Example 26

This example presents a film build ladder showing the characteristics resulting from changing the thickness of the clear topcoat prepared according to example 5A and applied to a base coating prepared according to example 12, Batch B. Six test panels were coated with a base coating composition prepared according to example 12 Batch B. The base coat film build for each panel was 2.0-2.5 mils. Each panel was subsequently coated with the clear coating composition of example 5A. The clear coating was applied at a variety of film build thickness. Color readings were taken on MacBeth spectrophotometer at the test conditions as employed in Example 8. The results are shown in Tables 40 and 41.

TABLE 40
Topcoat Film Build Ladder - Raw Color Numbers

| | Base Coat | Clear Coat | | | |
|---|---|---|---|---|---|
| Sam- | Film Build | Film Build | Lightness | +Red/−green | +Yellow/−blue |
| ple | (mils) | (mils) | (L*) | (a*) | (b*) |
| 1 | 2.1-2.5 | 1.0-1.1 | 70.483 | −2.595 | 13.009 |
| 2 | 2.3-2.5 | 1.2-1.4 | 70.146 | −2.900 | 15.201 |
| 3 | 2.0 | 1.2-1.5 | 69.741 | −3.056 | 15.748 |
| 4 | 2.3-2.5 | 1.6-2.1 | 69.645 | −3.373 | 18.153 |
| 5 | 2.3-2.5 | 2.2 | 69.521 | −3.790 | 20.386 |
| 6 | 2.0 | 2.4-2.7 | 69.212 | −3.678 | 19.814 |

Using Sample 1 as standard:

TABLE 41
Color Differences As Topcoat Film Build Changes

| Sample | DL* | Da* | Db* | DE* |
|---|---|---|---|---|
| 1 | — | — | — | — |
| 2 | −0.351 | −0.305 | 2.192 | 2.239 |
| 3 | −0.742 | −0.461 | 2.739 | 2.875 |
| 4 | −0.838 | −0.778 | 5.145 | 5.270 |
| 5 | −0.962 | −1.195 | 7.377 | 7.535 |
| 6 | −1.271 | −1.083 | 6.806 | 7.007 |

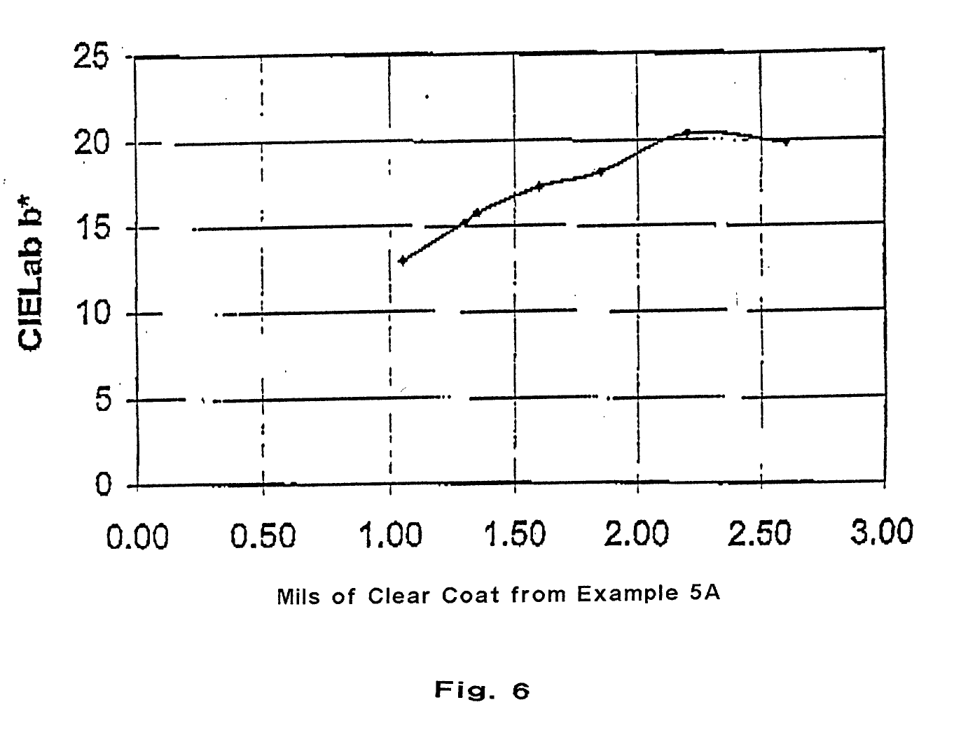

FIG. 6 shows a plot of CIELab b* vs. clear coat film build for the panels of the present example. There is a trend toward higher b* (yellow color) values with increasing film build. Visually this difference is perceptible, but very slight.

### Example 27

This example demonstrates the effect of base-coat cure on the color of panels prepared according to one aspect of the invention.

Test panels were prepared to include a base coating prepared according to example 12, Batch B and then cured at 375° F. for a period as listed in Table 42. The clear coating prepared according to example 5A was applied and cured at the same temperature for 15 minutes.

Panels were tested using MacBeth spectrophotometer at the test conditions described in Example 8. The test results are listed in Tables 42 and 43.

TABLE 42
Base Coat Cure Ladder - Raw Color Numbers

| | Base | Clear | | | | |
|---|---|---|---|---|---|---|
| | Coat | Coat | | | | |
| | Film | Film | Cure | | | +Yellow/ |
| | Build | Build | Time | Lightness | +Red/−green | blue |
| Sample | (mils) | (mils) | (min) | (L*) | (a*) | (b*) |
| 1 | 2.1-2.5 | 1.5-1.7 | 10 | 68.849 | −3.357 | 17.422 |
| 2 | 2.1-2.2 | 1.7-1.9 | 7 | 70.463 | −3.314 | 16.930 |
| 3 | 2.3-2.4 | 1.5-1.6 | 13 | 69.260 | −2.968 | 15.418 |

Using Sample 1 as standard:

TABLE 43
Base Coat Cure Ladder - Color Differences

| Sample | | DL* | Da* | Db* | DE* |
|---|---|---|---|---|---|
| | 1 | — | — | — | — |
| | 2 | 0.614 | 0.043 | −0.491 | 0.77 |
| | 3 | −0.589 | 0.338 | −2.004 | 2.124 |

### Example 28

This example demonstrates the effect of clear coat cure on the color of panels prepared according to one aspect of the invention. Color readings were taken using the MacBeth spectrophotometer, using settings as described in Example 8, above.

Test panels were prepared and tested according to the procedure in Example 27, except that the base coating was cured at 375° F. for 10 minutes and the clear coating was cured for 15 minutes at a temperature as listed in Table 44. The test results are listed in Tables 44 and 45.

TABLE 44
Clear Coat Cure Ladder - Raw Color Number

| | Base | Clear | Clear | | | |
|---|---|---|---|---|---|---|
| | Coat | Coat | Coat | | | |
| | Film | Film | Cure | | | |
| | Build | Build | Temp | Lightness | | |
| Sample | (mils) | (mils) | (° F.) | (L*) | +Red/−green (a*) | +Yellow/−blue (b*) |
| 1 | 2.0-2.3 | 1.6-1.7 | 325 | 70.430 | −0.766 | 5.020 |
| 2 | 2.1-2.2 | 1.4-1.5 | 350 | 59.753 | −1.635 | 8.576 |
| 3 | 2.1-2.5 | 1.5-1.7 | 375 | 69.865 | −3.314 | 17.240 |
| 4 | 2.2-2.4 | 1.5 | 400 | 69.706 | −4.265 | 24.521 |

Using Sample 1 as standard:

TABLE 45
Clear Coat Cure Ladder - Color Differences

| Sample | DL* | Da* | Db* | DE* |
|---|---|---|---|---|
| 1 | — | — | — | — |
| 2 | −0.677 | −0.869 | 3.556 | 3.723 |
| 3 | −0.565 | −2.548 | 12.220 | 12.500 |
| 4 | −0.724 | −3.499 | 19.501 | 19.826 |

A definite trend is apparent in the data presented in Tables 44 and 45 above. The panels become more green as a* value decreases, and significantly yellow as the b*value increases with higher cure temperatures. This color change is evident on visual inspection.

### Example 29

This example repeats the procedure of example 28, but varies cure time rather than cure temperature.

Test panels were prepared and tested according to the procedure in Example 28, except that the clear coating was cured at 375° F. for a period as listed in Table 46. Color readings were taken using the MacBeth spectrophotometer, using settings as described in Example 8. The test results are listed in Tables 46 and 47.

TABLE 46
Cure Time Ladder - Raw Color Numbers

| | Base | Clear | | | | |
|---|---|---|---|---|---|---|
| | Coat | Coat | | | | |
| | Film | Film | Cure | Light- | | |
| Sam- | Build | Build | Time | ness | +Red/−green | +Yellow/−blue |
| ple | (mils) | (mils) | (min) | (L*) | (a*) | (b*) |
| 1 | 2.3-2.5 | 2.2 | 15 | 69.535 | −3.779 | 20.371 |
| 2 | 2.2-2.5 | 1.9-2.1 | 10 | 70.489 | −2.756 | 14.121 |
| 3 | 2.0-2.2 | 1.9-2.0 | 5 | 70.515 | −1.703 | 9.384 |

Using Sample 1 as standard:

TABLE 47
Cure Time Ladder - Color Differences

| Sample No. | DL* | Da* | Db* | DE* |
|---|---|---|---|---|
| 1 | — | — | — | — |
| 2 | 0.954 | 1.023 | −6.250 | 6.404 |
| 3 | 0.980 | 2.076 | −10.986 | 11.223 |

Tables 46 and 47 show the same trend in color change as that in Example 28. Test panels become increasingly green and increasingly yellow as the cure time of the clear coating increases.

### Example 30

This example provides a film build ladder similar to that of Example 25.

Test panels were prepared and tested according to the procedure in Example 25, except that the base coating is formed of the powder coating composition of Example 6 and that the clear coating was applied to a target film build of 1.7-2.0 mils. Color readings were taken using the MacBeth spectrophotometer, using settings as described in Example 8. The test results are shown in Tables 48 and 49 below.

TABLE 48
Base Coat Film Build Ladder - Raw Color Number

| | Base | Clear | | | |
|---|---|---|---|---|---|
| | Coat | Coat | | | |
| | Film | Film | | | |
| | Build | Build | Lightness | +Red/−green | +YelIow/−blue |
| Sample | (mils) | (mils) | (L*) | (a*) | (b*) |
| 1 | 1.2-1.4 | 1.8-1.9 | 73.819 | −3.955 | 19.329 |
| 2 | 1.6-1.8 | 1.7-1.8 | 73.307 | −3.992 | 19.159 |
| 3 | 2.1-2.2 | 1.7-1.9 | 72.972 | −4.222 | 20.851 |
| 4 | 2.5-2.7 | 1.7 | 73.702 | −4.323 | 21.061 |
| 5 | 3.5-3.8 | 1.8-2.0 | 73.650 | −4.659 | 22.733 |
| 6 | 4.0-4.4 | 1.7-1.8 | 73.557 | −4.253 | 20.279 |
| 7 | 5.9-6.0 | 1.7-1.9 | 73.803 | −4.585 | 22.418 |

Using Sample 1 as standard:

TABLE 49
Base Coat Film Build Ladder - Color Differences

| Sample | DL* | Da* | Db* | DE* |
|---|---|---|---|---|
| 1 | — | — | — | — |
| 2 | −0.513 | −0.036 | −0.170 | 0.541 |
| 3 | −0.847 | −0.267 | 1.522 | 1.762 |
| 4 | −0.117 | −0.368 | 1.733 | 1.775 |
| 5 | −0.169 | −0.704 | 3.495 | 3.481 |
| 6 | −0.26 | −0.298 | 0.950 | 1.029 |
| 7 | −0.016 | −0.629 | 3.090 | 3.153 |

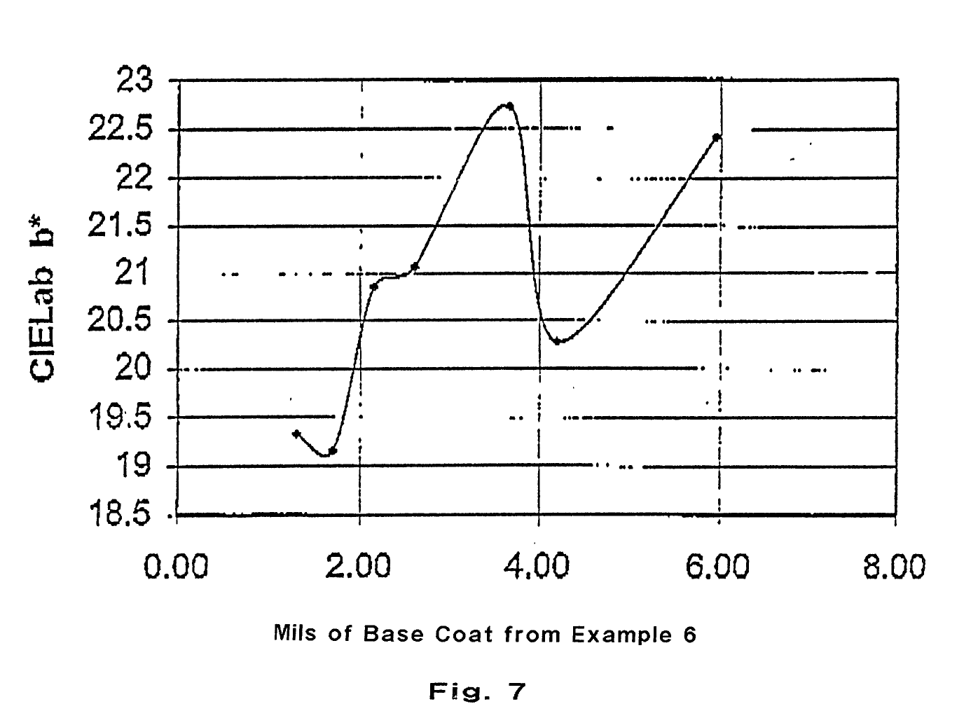

FIG. 7 shows the data of the present example represented as a plot of CIELab b* value vs. base coat thickness. As in example 25, above, there is a trend toward yellow (higher b*) with increasing base coat film build. The panels show little, if any, visually perceptible difference in color, however.

### Example 31

This example investigates the effect of using a glycidyl methacrylate (GMA) based powder coating composition prepared in Example 3 as a clear coating in the practice of the invention.

The recommended cure schedule for the GMA clear coat prepared in example 3 is 20 minutes, at 325° Fahrenheit. Test panels were prepared by electrostatic spray coating and subsequent cure of a base coating made of the powder coating composition of example 12, Batch B. Thereafter, the GMA based clear coating was applied and cured according to two different cure schedules as listed in Table 50. The color of the resultant panels was measured using MacBeth spectrophotometer with the test conditions as described in Example 8. The test results are shown in Tables 50 and 51.

TABLE 50
GMA Clear Coat - Raw Color Numbers

| | Base Coat | Clear Coat | Cure | Cure | | | |
|---|---|---|---|---|---|---|---|
| | Film Build | Film Build | Temp. | Time | Lightness | | |
| Sample | (mils) | (mils) | (° F.) | (min.) | (L*) | +Red/−green (a*) | +Yellow/−blue (b*) |
| 1 | 2.4-2.5 | 0 | N/A | N/A | 76.109 | 0.403 | 1.455 |
| 2 | 1.9-2.2 | 1.8-2.0 | 325 | 15 | 71.513 | −0.319 | 2.725 |
| 3 | 2.1-2.3 | 1.9 | 375 | 15 | 71.557 | −1.304 | 6.583 |

Using Sample 1 (no clear coat) as standard:

TABLE 51
GMA Clear Coat - Color Differences

| Sample No. | DL* | Da* | Db* | DE* |
|---|---|---|---|---|
| 1 | — | — | — | — |
| 2 | −4.596 | −0.722 | 1.270 | 4.823 |
| 3 | −4.552 | −1.707 | 5.128 | 7.066 |

The test panels prepared according to this example exhibit a greenish/yellowish bright brass color, as desired. This effect is not as dramatic as that observed on panels prepared with the same base coat composition, but top-coated with the powder coat composition of example 5A, as described in examples 23-30. Nonetheless, sample No. 3, cured at 375° F. for 15 minutes shows the desired greenish/yellowish bright brass color. By incorporating more organic pigment, or by curing at higher temperatures, or for longer times, additional coloration, as desired, would be available.

### Example 32

The present example examines a Q-Panel coated with a base coating prepared according to example 7, without clear coat. The Q-Panel was prepared by electrostatically spraying the powder coating composition of Example 7, followed by curing at 400° F. for 10 minutes. Variability of color from location to location was measured using MacBeth spectrophotometer at the settings as described in Example 8. The test results are shown in Tables 52 and 53.

TABLE 52
No Clear Coat - Raw Color Numbers

| | Lightness (L*) | +Red/−green (a*) | +Yellow/−blue (b*) |
|---|---|---|---|
| Location #1 | 72.192 | 9.724 | 8.822 |
| Location #2 | 71.553 | 10.114 | 9.361 |
| Location #3 | 70.801 | 10.375 | 9.75 |

Location #1 was used as standard:

TABLE 53
No Clear Coat - Color Differences

| | DL* | Da* | Db* | DE* |
|---|---|---|---|---|
| Location #1 | — | — | — | — |
| Location #2 | −0.639 | 0.390 | 0.539 | 0.922 |
| Location #3 | −1.391 | 0.651 | 0.964 | 1.813 |

The resultant panel, measured above, appears orange/pink with a metallic flake appearance to visual inspection.

### Example 33

This example examines a Q-Panel coated with a base coating prepared according to Example 7, and subsequently clear coated with a powder coating composition prepared according to example 5A.

The Q-Panel was prepared by electrostatic spray of the base coating composition of Example 7, followed by curing at 400° F. for 10 minutes. Base coat film build was 2.1-2.3 mils. The clear coating composition of example 5A was applied and cured for 15 minutes at 375° F. with a film build of 1.9-2.1 mils. Variability of color from point-to-point on one panel was tested using MacBeth spectrophotometer at the settings described in Example 8. The panel of Example 32 (i.e., no clear coating) was used as standard. Test results are shown in Tables 54 and 55.

TABLE 54

| Panel of | Lightness (L*) | +Red/−green (a*) | +Yellow/−blue (b*) |
|---|---|---|---|
| Example 32 | 72.192 | 9.724 | 8.822 |
| Example 33 | 73.864 | 3.150 | 21.897 |

Using test panel of Example 32 as standard:

TABLE 55

| Panel of | DL* | Da* | Db* | DE* |
|---|---|---|---|---|
| Example 32 | — | — | — | — |
| Example 33 | 1.672 | −6.574 | 13.075 | 14.730 |

Even a metallic powder coating including non-leafing aluminum, when blended with orange pigment and coated with polyester clear coat, produces a color change on the order of that seen in using the composition of example 6, as described in example 11.

### Example 34

In this example, a comparison was made between the coloration of a first panel including a base coating prepared with the powder coating composition of Example 12, Batch B and that of a second panel including a base coating prepared with the powder coating composition of Example 6. Both the first and second panels were also coated with a top coating prepared using the powder coating composition of example 5A. Panels were tested using MacBeth spectrophotometer at the settings employed in Example 8. The test results are shown in Tables 56 and 57.

TABLE 56

| | Base Coat | Top Coat | Light- | | |
|---|---|---|---|---|---|
| | Film Build | Film Build | ness | +Red/−green | +Yellow/−blue |
| Panel | (mils) | (mils) | (L*) | (a*) | (b*) |
| First | 2.3-2.5 | 1.6-2.1 | 69.581 | −3.329 | 18.183 |
| Second | 2.1-2.2 | 1.7-1.9 | 72.994 | −4.263 | 21.044 |

Using first panel as standard:

TABLE 57

| Panel | DL* | Da* | Db* | DE* |
|---|---|---|---|---|
| First | — | — | — | — |
| Second | 3.414 | −0.934 | 2.860 | 4.551 |

Some color difference was apparent between the two panels on visual inspection. Both panels, however, exhibited an appearance similar to that of bright brass.

### Example 35

In this example a conventional approach to provide a colored reflective metallic coating was investigated. A conventional approach to produce an article having colored reflective metallic coating includes adding chromatic pigment in small concentration to a clear coating composition. The pigmented clear coating composition is then applied on a metallic or reflective base coating. The article exhibits a translucent tinted chromatic appearance.

Several panels were coated with a base coating formed of IF7567 powder coating composition and cured as described in Example 8. The panels were subsequently coated by electrostatic spraying a tinted clear coating composition as described in Example 5B. The panels were cured for 15 minutes at 375° F. One panel having the base coat film build of 1.8-2.1 mils and the tinted clear coat film build of 2.1-2.3 mils was tested using the MacBeth spectrometer at the settings as described in Example 8. The test results are shown in Tables 58 and 59.

TABLE 58

| | Lightness (L*) | +Red/−green (a*) | +Yellow/−blue (b*) |
|---|---|---|---|
| Location #1 | 66.520 | 5.130 | 36.054 |
| Location #2 | 64.736 | 6.441 | 37.881 |
| Location #3 | 66.720 | 5.102 | 35.893 |

Using Location #1 as standard:

TABLE 59
Color differences

| | Dl* | Da* | Db* | DE* |
|---|---|---|---|---|
| Location #1 | — | — | — | — |
| Location #2 | −1.784 | 1.311 | 1.827 | 2.870 |
| Location #3 | 0.200 | −0.029 | −0.161 | 0.258 |

Inconsistent coloration across the surface of the test panel was visible on the measured panel as well as other panels prepared in the same fashion.

### Example 36

Test panels were prepared according to the procedure in Example 35, except that the tinted clear coating composition was applied at various film build thickness. Color measurements were taken on MacBeth spectrophotometer at the settings as described in Example 8 to assess the effect of tinted clear coat film build on the color of the panels. The test results are shown in Tables 60 and 61.

TABLE 60

| | Base | Tinted | | | |
|---|---|---|---|---|---|
| | Coat | Clear | | | |
| | Film | Coat | Light- | | |
| | Build | Film | ness | +Red/−green | +Yellow/−blue |
| Sample | (mils) | Build (mils) | (L*) | (a*) | (b*) |
| 1 | 2.0-2.2 | 0.9 | 71.943 | 0.462 | 17.299 |
| 2 | 1.9-2.2 | 1.2-1.3 | 69.119 | 1.450 | 24.121 |
| 3 | 2.0-2.2 | 2.2-2.3 | 66.730 | 4.301 | 33.925 |
| 4 | 1.8-2.1 | 2.1-2.3 | 66.520 | 5.130 | 36.054 |

Using Sample 1 as standard:

TABLE 61

| Sample | DL* | Da* | Db* | DE* |
|---|---|---|---|---|
| 1 | — | — | — | — |
| 2 | −2.824 | 0.988 | 6.822 | 7.449 |
| 3 | −5.214 | 3.839 | 16.626 | 17.843 |
| 4 | −5.423 | 4.668 | 18.755 | 20.074 |

A significant color shift, as a function of the tinted clear coat film build, is evident on visual inspection as well as from the data presented in Tables 60 and 61 above. Comparing the results with those developed in Example 26 shows that the color of a coating formed of a pigmented clear coating over a metallic reflective base coating is much more variable, as a function of pigmented clear coat film build thickness. The color of a coating prepared according to Example 26 is much more consistent and the color change is considerably less than that observed with Examples 35 and 36.

### Example 37

In this example, a panel was prepared by applying a pigmented clear coating composition of Example 5B over a reflective base coating formed of IF7567, at various film build thickness. The color of the resultant coatings was then compared with the color of a panel coated only with a base coating form of IF7567. Color measurements were taken on MacBeth spectrophotometer at the settings as described in Example 8 to assess the effect of the pigmented clear coat film build on the color of the panel. The test results are shown in Tables 62 and 63 below.

TABLE 62

| | Pigmented | | | |
|---|---|---|---|---|
| | Clear Coat | | | |
| | Film Build | Lightness | +Red/−green | +Yellow/−blue |
| Sample | (mils) | (L*) | (a*) | (b*) |
| 1 | 0 | 79.903 | −0.059 | 1.267 |
| 2 | 0.9 | 71.943 | 0.462 | 17.299 |
| 3 | 1.2-1.3 | 69.878 | 1.014 | 21.711 |
| 4 | 2.2-2.3 | 67.503 | 3.645 | 32.241 |
| 5 | 2.2-2.3 | 66.496 | 5.162 | 36.042 |

Using Sample 1 as standard:

TABLE 63

| Sample | DL* | Da* | Db* | DE* |
|---|---|---|---|---|
| 1 | — | — | — | — |
| 2 | −7.439 | 0.292 | 13.719 | 15.609 |
| 3 | −10.026 | 1.073 | 20.444 | 22.795 |
| 4 | −12.400 | 3.704 | 30.974 | 33.569 |
| 5 | −13.407 | 5.222 | 34.775 | 37.634 |

### Example 38

Panels were prepared and tested according to the procedure of Example 29, except that the film builds and the clear coating cure time were as listed in Table 64. Color readings were taken using the MacBeth spectrophotometer, using settings as described in Example 8. The test results are listed in Tables 64 and 65.

TABLE 64

| | | | Clear | | | |
|---|---|---|---|---|---|---|
| | | | Coat | | | |
| | Base Coat | Clear Coat | Cure | | +Red/ | +Yellow/ |
| Sam- | Film Build | Film Build | Time | Lightness | −green | −blue |
| ple | (mils) | (mils) | (min) | (L*) | (a*) | (b*) |
| 1 | 2.0-2.3 | 1.9-2.0 | 5 | 70.341 | −1.675 | 9.424 |
| 2 | 2.2-2.5 | 1.9-2.1 | 10 | 70.413 | −2.690 | 14.089 |
| 3 | 2.1-2.4 | 1.7-1.4 | 15 | 70.230 | −3.036 | 16.071 |
| 4 | 2.3-2.5 | 1.6-2.1 | 15 | 69.363 | −2.672 | 16.503 |
| 5 | 2.0-2.1 | 1.8-1.9 | 20 | 69.861 | −3.144 | 16.903 |
| 6 | 2.2-2.3 | 1.7 | 30 | 70.182 | −3.022 | 16.580 |
| 7 | 2.2-2.3 | 1.6-1.9 | 45 | 70.514 | −3.660 | 19.814 |
| 8 | 1.9-2.1 | 1.8-1.9 | 60 | 69.929 | −3.802 | 20.638 |

Using Sample 1 as standard:

TABLE 65

| Sample | DL* | Da* | Db* | DE* |
|---|---|---|---|---|
| 1 | — | — | — | — |
| 2 | 0.072 | −1.015 | 4.665 | 4.774 |
| 3 | −0.112 | −1.360 | 6.647 | 6.785 |
| 4 | −0.979 | −0.997 | 7.079 | 7.215 |
| 5 | −0.480 | −1.469 | 7.479 | 7.637 |
| 6 | −0.159 | −1.346 | 7.156 | 7.283 |
| 7 | 0.172 | −1.985 | 10.390 | 10.580 |
| 8 | −0.412 | −2.126 | 11.214 | 11.421 |

While there is a trend toward yellow (+b*) and perhaps red (+a*) with longer cure time, it takes a significant increase in cure time to affect a modest change in color. For a cure temperature of 375° F., the color of the final coatings is fairly consistent for a clear coat cure time of from 10 minutes to 30 minutes. Only a slight color difference is visually perceptible among sample panels.

### Example 39

Powder coating compositions as listed in Table 66 were prepared by mixing the ingredients. Samples No. 1-3 were each blended by manually shaking the ingredients in a bag for 30 seconds. Sample No. 4 was blended in the Mixaco™ mixer for 1 minute at 265 RPM. Panels were prepared by applying each of the base coating compositions on a test panel and cured. Thereafter, powder coating composition IF 4444 was applied as a clear coating and cured for 15 minutes at 375° F.

TABLE 66

| Sample No. | 1 | 2 | 3 | 4 |
|---|---|---|---|---|
| IF 9299 TGIC based metallic | 99.75 | 99.85 | 99.65 | — |
| powder coating (g) | | | | |
| IF 7567 (g) | — | — | — | 99.85 |
| Modified azo orange pigment (g) | 0.25 | 0.15 | 0.35 | 0.15 |

### Example 40

In this example, inorganic black and white pigments were tested for coloring effect. Base coating compositions as listed in Table 67 were prepared by blending the ingredients at ambient temperature to obtain pigmented metallic powder coating compositions. The compositions were applied by electrostatic spray on test panels and cured. Subsequently, an IF4444 powder coating composition was applied over the base coatings and cured at 375° F. for 15 minutes. To each sample panel was designated the same letter as that for the base powder coating composition.

TABLE 67

| | Sample No. | | | | |
|---|---|---|---|---|---|
| | A | B | C | D | E |
| IF 7567 | 98% | 98% | 98% | 95% | 95% |
| Black Iron Oxide | 2% | — | — | — | — |
| Black IG (copper chromate) | — | 2% | — | — | — |
| Carbon black | — | — | 2% | — | — |
| Zinc Oxide | — | — | — | 5% | — |
| Titanium Dioxide | — | — | — | — | 5% |

The gloss of each sample panel was measured at 20° angle. The color of the panels was visual inspected and compared to a comparison panel coated with unpigmented IF7567 as based coating and IF4444 as clear coating. The results are listed as follows:

Sample panel A had 20° gloss of 266. There was no color difference from the comparison panel.

Sample panel B had 20° gloss of 266. There was no color difference from the comparison panel.

Sample panel C had 20° gloss of 266 and very poor application properties. The color was duller, more orange and yellow than that of the comparison panel.

Sample panel D had 20° gloss of 254. The color was dull but the undertone did not differ substantially from that of the comparison panel.

Sample panel E had 20° gloss of 286. The color was dull but the undertone did not differ substantially from that of the comparison panel.

Overall, the inorganic pigments tested in the example seemed to contribute to the color in a manner different from the organic pigments.

### Example 41

Powder coating compositions as listed in Table 68 were prepared by dry blending the ingredients in a blender for 5 to 10 second. The resultant compositions were electrostatically sprayed on panels and cured at 400° F. for 15 min to form base coatings. Panels were then coated with a clear coating composition IF 4444 and cured at 400° F. for 10 min. To each sample panel was designated the same letter as that for the base powder coating composition. The gloss of each sample panel was measured at 20° and 60° angles, respectively. The results are listed in Table 69.

TABLE 68

| Sample | A | B | C | D | E | F | G | H | I | J | K | L |
|---|---|---|---|---|---|---|---|---|---|---|---|---|
| IF 4024* (g) | 99.75 | 99.90 | 99.90 | 99.90 | 99.90 | 99.90 | 99.90 | 99.90 | 99.86 | 99.90 | 99.95 | 99.50 |
| Modified azo orange | 25.00 | — | 0.10 | — | — | — | — | — | — | 0.0625 | 0.025 | 0.25 |
| pigment (g) | | | | | | | | | | | | |
| Dis azo Pigment | — | .10 | — | — | — | — | — | — | — | 0.025 | — | — |
| Orange 34 (g) | | | | | | | | | | | | |
| Naphtol Red CI Red | — | — | — | 0.10 | 0.10 | — | — | — | 0.10 | 0.050 | — | 0.25 |
| 170 (g) | | | | | | | | | | | | |
| Pigment Orange 36 | — | — | — | — | — | 0.10 | — | — | — | — | 0.025 | — |
| (g) | | | | | | | | | | | | |
| Pigment Yellow 194 | — | — | — | — | — | — | 0.10 | — | — | — | — | — |
| (g) | | | | | | | | | | | | |
| Pigment Orange 34 | — | — | — | — | — | — | — | 0.10 | — | — | — | — |
| (g) | | | | | | | | | | | | |

*a Urethane based metallic powder coating composition commercially available from H. B. Fuller Company

TABLE 69

| Panel | Gloss at 20° | Gloss at 60° |
|---|---|---|
| Comparison 1* | 641 | 493 |
| Comparison 2** | 314 | 237 |
| A | 280 | 212 |
| B | 303 | 324 |
| C | 227 | 335 |
| D | 308 | 225 |
| E | 302 | 217 |
| F | 375 | 252 |
| G | 335 | 237 |
| H | 335 | 238 |
| I | 304 | 226 |
| J | 303 | 219 |
| K | 377 | 251 |
| L | 308 | 223 |

*panel was coated only with IF4024.
**panel was coated with IF4024 and then with IF4444.

The comparison panel had a metallic reflective appearance. Each of the panels prepared according to the invention had a specific colored reflective appearance. That is, it had a specific color, such as, polished brass, copper, bronze, or gold, depending on the specific pigment used in the composition, while maintaining the metallic reflectivity.

### Example 42

Powder coating compositions as listed in Table 70 were prepared by mixing the ingredients in a bag and shaking for 30 seconds. Each of the resultant compositions was applied on a test panel and cured at 375° F. for 15 minutes. Thereafter, a powder coating composition IF4444 was applied as a clear coating and cured at 375° F. for 15 minutes. To each sample panel was designated the same letter as that for the base powder coating composition.

TABLE 70

| | A | B | C | D |
|---|---|---|---|---|
| | Weight | Weight | Weight | Weight |
| Ingredients | (g) | (g) | (g) | (g) |
| IF7567 | 99.75 | 99.86 | 99.5 | 99.85 |
| Modified azo orange pigment | 0.25 | 0.625 | 0.25 | — |
| Naphtol Red CI Pigment Red 170 | — | 0.060 | 0.25 | 0.15 |
| Dis azo Pigment Orange 34 | — | 0.025 | — | — |

The panels were evaluated qualitatively as follows:

Panel A exhibited a brass color.

Panel B exhibited a gold color.

Panel C exhibited a bronze color.

Panel D exhibited an electric pink color.

We claim:

1. A process for powder coating a substrate comprising:
a). applying a base powder coating composition on at least one surface of said substrate to form a base coating thereon, said base powder coating composition comprising at least one film-forming polymer, at least one chromatic pigment, and at least one metallic-effect pigment;
b.) applying a clear powder coating composition that is substantially free of chromatic pigment on top of said base coating to form a clear coating; and
c). curing said base coating and said clear coating under cure conditions effective to cause at least a portion of said chromatic pigment to migrate from said base coating into said clear coating to produce a chromatic and metallic effect appearance.

2. The process of claim 1, wherein said base coating is heated prior to applying said clear coating.

3. The process of claim 1, wherein said base coating is cured prior to applying said clear coating.

4. The process of claim 1, wherein said at least one chromatic pigment and said at least one metallic-effect pigment are blended into said base powder coating composition

5. The process of claim 1, wherein said at least one metallic-effect pigment comprises leafing and non-leafing metallic pigment or micas.

6. The process of claim 1, wherein said at least one metallic-effect pigment is present in an amount of from about 0.1 wt % to about 25 wt %.

7. The process of claim 1, wherein said at least one chromatic pigment is present in an amount of from about 0.01 wt % to about 50 wt %.

8. The process of claim 1, wherein said clear powder coating composition comprises at least one film forming polymer chosen from epoxy resins, acrylic resins and polyester resins.

9. The process of claim 1, wherein said curing is at a temperature of no less than about 275° F. for a period of from about 1 minute to about 1 hour.

10. The process of claim 3, wherein said curing is at a temperature of no less than about 275° F. for a period of from about 1 minute to about 1 hour.

11. An article produced by the process of claim 1, comprising:
a substrate having at least one surface;
a cured base coating on said at least one surface of said substrate, said base coating being produced from a base powder coating composition comprising at least one film-forming polymer, at least one chromatic pigment, and at least one metallic-effect pigment; and
a cured clear coating on top of said base coating, said clear coating being produced from a clear powder coating composition that is substantially free of chromatic pigment, wherein said article exhibits a chromatic and metallic effect appearance caused by at least a portion of said chromatic pigment's migrating from said base coating into said clear coating during cure.

12. A two-part powder coating system comprising:
a first part including a first substantially uniform powder mixture comprising at least one film-forming polymer, at least one chromatic pigment, and at least one metallic-effect pigment;
a second part including a second substantially uniform powder mixture comprising at least one film-forming polymer and being substantially free of chromatic pigment, wherein said first part, when applied to at least one surface of a substrate to form a base coating and cured in the absence of said second part, is adapted to reflect incident white light in a color substantially independent of the color of said chromatic pigment, and wherein said second part, when applied to the top of said base coating to form a clear coating and cured, is adapted to reflect incident white light in a color that is a function of the color of said chromatic pigment.

13. The two-part powder coating system of claim 12, wherein said at least one metallic-effect pigment comprises leafing and non-leafing metallic pigment or micas.

14. The two-part powder coating system of claim 12, wherein said at least one metallic-effect pigment is present in an amount of from about 0.1 wt % to about 25 wt %.

15. The two-part powder coating system of claim 12, wherein said at least one chromatic pigment is present in an amount of from about 0.01 wt % to about 50 wt %.

16. The two-part powder coating system of claim 12, wherein said at least one film forming polymer in said clear powder coating composition comprises epoxy resins, acrylic resins or polyester resins.
